(19) United States
(12) Patent Application Publication
(10) Pub. No.: US 2011/0083595 A1
(43) Pub. Date: Apr. 14, 2011

(54) DISK FOR THE DOSAGE AND INDIVIDUAL SELECTION OF SEEDS, UNIT FOR THE DOSAGE AND LONG-DISTANCE TRANSPORT OF SEEDS COMPRISING SAID DISK, AND METHOD FOR THE DOSAGE, INDIVIDUAL SELECTION AND LONG-DISTANCE TRANSPORT OF SEEDS

(75) Inventor: Mauro Collovati, Teor (IT)

(73) Assignee: TONUTTI TECNOAGRICOLA SRL, Remanzacco (IT)

(21) Appl. No.: 12/999,748

(22) PCT Filed: Jun. 18, 2009
(86) PCT No.: PCT/IB09/05966

§ 371 Date: Dec. 17, 2010

(30) Foreign Application Priority Data
Jun. 19, 2008 (IT) UD2008A000139

(51) Int. Cl. A01C 7/04

(52) U.S. Cl. 111/174

(57) ABSTRACT

A disk for the dosage and individual selection of seeds, having a determinate axial thickness delimited by two facing circular walls or surfaces, and comprising housing seatings made along the peripheral edge of one or both circular walls or surfaces and passage ways that open from the housing seatings toward the outside of the disk, for the passage of a stream of air. The passage ways are made on the axial thickness, in a radial direction with respect to the center of the disk.

### FIELD OF THE INVENTION

The present invention concerns a disk for the dosage and individual selection of seeds, particularly maize, rape, soya, wheat or other seeds to be measured out for agronomic needs or due to the cost of the seed, and a unit for the dosage and long-distance transport of seeds comprising said disk, of the type used in a machine for the dosage and individual selection of seeds in the field of production of agricultural machinery, and in particular in precision seeders, able to discharge one seed at a time in the desired positions.

### BACKGROUND OF THE INVENTION

A unit for the dosage of seeds of the pneumatic type is known, which works under pressure or under depression and comprises a rotating disk with through holes through the plane on which the disk lies, disposed on the same circumference and cooperating, on one side, with a seed loading chamber and on the opposite side, and only for a defined circular sector, with a chamber associated with aeraulic, suction or pressing means, according to the two known solutions.

The suction or pressure occurs orthogonally to the plane on which the rotating disk lies, through said holes.

The suction or the pressure created determines the retention of each individual seed in every hole, until the seed comes out from the suction or pressure sector and therefore is no longer held back and falls to the ground. Breather holes or air intakes are provided on the side opposite the suction or pressure side.

This known solution has the disadvantage of being very bulky because of the need to provide lateral breather holes or air intakes.

Moreover, since the stream of air, suction or pressing, occurs orthogonally to the rotating disk, the dosage unit necessarily develops along the axis of the disk, and is thus very bulky in this direction too. In particular the assembly of several disks in a battery is in practice made impossible since both the loading of the seeds and the action of the air which holds the seed occur in a direction orthogonal to the plane of the disk, and it is therefore necessary to provide a determinate axial spacing, or gap, between one disk and another or between one dosage body and another.

In practice, this limits the possibility of installing a number of rotating disks in parallel on the same rotating hub, because the bulk that would be created is excessive and indeed in the state of the art only dosage units with a single disk are used. This is a disadvantage above all in those agricultural applications in which, for particular agronomic requirements, it is necessary to operate in the field with an ample working front, which can vary between a few meters to as much as 20 meters.

Moreover, to guarantee the uniformity and the constancy of the action of the air, whether it be suction air or pressing air, it is necessary to create tangential packing elements, to avoid leakages in this direction: this complicates the practical creation of the machine and increases the costs thereof.

Purpose of the present invention is to create a disk for the dosage and the individual selection of seeds and a unit for the dosage and long-distance transport of seeds for a seed dispensing machine, which have a less complex and bulky structure and which cost less to make than the machines known in the state of the art, while still maintaining the capacity of distributing the seeds with precision, and also allowing the application of the machine on ample working fronts.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with a first feature of the present invention, a disk for the dosage and individual selection of seeds has a determinate axial thickness delimited by two circular walls or surfaces facing each other. Housing seatings for the seeds are made along the peripheral edge of one or both circular walls or surfaces, so as to create a honeycomb geometry of the edge of the disk.

Passage ways are also provided which open from the housing seatings toward the outside of the disk, for the passage, toward the outside of the disk, of a desired stream of air.

In accordance with a characteristic feature of the present invention, the above passage ways are made on the axial thickness of the disk in a radial direction with respect to the centre of the disk itself.

Therefore, depending on whether the housing seatings are on one wall (single disk) or on both (double disk) the circular walls or surfaces of the disk, there will be radial passage ways on one or both the walls or surfaces.

Advantageously, the stream of air exiting from the radial passage ways occurs substantially in the plane on which the disk lies and not orthogonally to it, as in the state of the art.

The solution according to the present invention, in this way, allows the radial discharge of the pressurized air normally used in automatic distributors of seeds, allowing to reduce the overall bulk of the disks, which can, therefore, be coupled adjacent and contiguous to each other without compromising their functionality.

In accordance with a second feature of the present invention, a unit for the dosage and long-distance transport of seeds comprises at least a disk as described above.

For example, the single body of the unit for the dosage and long-distance transport of seeds can include one or more dosing disks.

According to one solution, the unit for the dosage and long-distance transport of seeds can provide a single dosing and individual selection disk.

An advantageous application of the present invention uses several dosing disks assembled in a battery.

According to an advantageous solution, the unit for the dosage and long-distance transport of seeds comprises a plurality of disks assembled on a rotating shaft, so as to achieve one or more dosing and individual selection drums.

The single body of the unit for the dosage and long-distance transport of seeds can also be used individually dosing one or more rows of seeds, or several bodies may be provided, assembled contiguous, each with an individual disk, or again, units of multiple dosage and individual selection bodies can be made, adjacent with double or specular disks, minimizing the overall bulk of the unit for the dosage and long-distance transport of seeds.

There is also, at least a loading chamber into which the seeds are fed and into which a first stream of pressurized air is introduced at a determinate speed.

In cooperation with the loading chamber at least a relative dosage and individual selection disk is assembled, advantageously two disks, at the sides of the chamber, so that the loading chamber is closed to the passage to the outside of the first stream of pressurized air, with the exception of the passage ways of each disk.

According to an advantageous form of embodiment, the unit for the dosage and long-distance transport of seeds comprises at least a retaining edge made laterally to the loading chamber in cooperation with the peripheral edge of the disk, for a determinate first angular sector of the disk itself, in order to retain the seeds in the housing seatings.

The retaining edge is shaped to mate with the disk and allows the seeds to rest thereon, preventing any separation caused by the centrifugal force of the rotation of the disk and allowing to operate at high rotation speeds.

A first pressurization pipe is also provided, advantageously positioned on the bottom of the loading chamber and able to introduce the first stream of pressurized air inside the loading chamber.

The first stream of air is able to pass outside the loading chamber only through the passage ways of each disk, and in said passage the first stream of air is able to maintain the seeds in the respective housing seatings, thanks to the generation of an effect of suction depression.

The unit for the dosage and long-distance transport of seeds also comprises a closing element positioned upstream of the retaining edge, with respect to the direction of rotation of the disk, which is located in cooperation with the axial thickness of the disk for a determinate second angular sector of the disk, upstream, with respect to the direction of rotation of the disk, of the first angular sector. In this way, the closing element is able to close the passage ways, only for said second angular sector. Consequently there is no longer the suction effect which keeps the seeds, which tend to fall, leaving the disk, because of gravity.

The seed can thus leave the disk to fall naturally, due to the force of gravity, once it is no longer held in the housing seating.

Alternatively, the unit for the dosage and long-distance transport of seeds comprises an expulsion pipe through which the seed is transported toward the outside, advantageously by means of a stream of accelerating air.

In fact, according to a variant embodiment, in order to discharge and transport the seeds a long distance, the unit for the dosage and long-distance transport of seeds comprises a second pipe, which is located substantially on the top of the loading chamber and is able to introduce a second stream of accelerating air, at a higher speed than the first stream of air, toward the seeds travelling along said second angular sector in which the passage ways are closed by the closing element, so as to act on the seed, accelerating it toward the expulsion pipe, so as to meet the requirement of transporting the seeds to a greater distance.

According to a further advantageous variant, the unit for the dosage and long-distance transport of seeds comprises a third pipe, as an alternative or as an aid to the second pipe, which is able to introduce a third stream of air into the loading chamber directed toward the disk, substantially aligned with a relative passage way of the disk.

According to a further feature of the present invention, a machine for the dosage, individual selection and long-distance transport of seeds comprises a unit for the dosage and long-distance transport of seeds as described above.

In accordance with another feature of the present invention, a method for the dosage, individual selection and long-distance transport of seeds comprises a first step of loading a single seed into housing seatings made along the peripheral edge of one or both circular walls or surfaces of a dosage and individual selection disk made to rotate around its axis.

The method according to the present invention also comprises:

a second step in which, for a first determinate angular sector of rotation of the disk, a first stream of pressurized air is achieved, exiting radially, with respect to the disk, from each of the seatings housing the seeds, so as to retain the seed in the relative housing seating, by means of a suction effect generated by the stream of air itself;

a third step in which, for a second determinate angular sector of rotation of the disk, in correspondence with a determinate point of detachment, the exit of the first stream of pressurized air is prevented, so as to eliminate said suction effect acting on the seed, so as to allow the seed to exit from the housing seating.

According to one solution of the present invention, the seed can be discharged from the disk by falling freely due to the action of the force of gravity, once the suction effect on the seed no longer continues.

According to a variant solution, there is a fourth step in which the seed, in substantial correspondence with the point of detachment, is subjected to the acceleration force of a second stream of accelerating air, at a greater speed than the first stream, which transports it toward the outside of the disk, in order to be distributed. Advantageously, the second stream of air has a direction substantially tangential to the outside circumference of the dosage and individual selection disk and involves an accelerated and forced discharge of the seed from the disk, useful to transport it long distance.

According to a further form of embodiment, the seed, in substantial correspondence with the point of detachment, is subjected to a third stream of pressurized air, directed substantially radial with respect to the disk, which discharges it from the disk. The third stream acts advantageously also to clean the disk, in particular its honeycomb part and guarantees the uniform detachment of the seed.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a three dimensional view of two dosage and individual selection disks according to the present invention;

FIG. 2 is a front view of the two disks in FIG. 1;

FIG. 3 is a lateral view of the two disks in FIG. 1;

FIG. 4 is a front view of a variant of the two disks in FIG. 1;

FIG. 5 is a three dimensional view of the variant of disks in FIG. 4;

FIG. 6 is a lateral view of the disks in FIG. 4, associated with a retaining edge;

FIG. 7 is a front view of FIG. 6;

FIG. 8 is a lateral view of a unit for the dosage and long-distance transport of seeds according to the present invention;

FIG. 9 is a front view of the unit for the dosage and long-distance transport of seeds in FIG. 8;

FIG. 10 is a three dimensional view of the unit for the dosage and long-distance transport of seeds in FIG. 8;

FIG. 11 is a schematic representation of the working of the unit for the dosage and long-distance transport of seeds in FIG. 8;

FIG. 12 is a schematic representation of a first condition of a seed housed in the disk according to the present invention;

FIG. 13 is a schematic representation of a second condition of a seed housed in the disk according to the present invention;

FIG. 14 is a schematic representation of a third condition of a seed housed in the disk according to the present invention;

FIG. 15 is a representation of a first form of embodiment of part of the unit for the dosage and long-distance transport of seeds in FIG. 8;

FIG. 16 is a representation of a second form of embodiment of part of the unit for the dosage and long-distance transport of seeds in FIG. 8;

FIG. 17 is a representation of a third form of embodiment of part of the unit for the dosage and long-distance transport of seeds in FIG. 8.

### DETAILED DESCRIPTION OF A PREFERENTIAL FORM OF EMBODIMENT

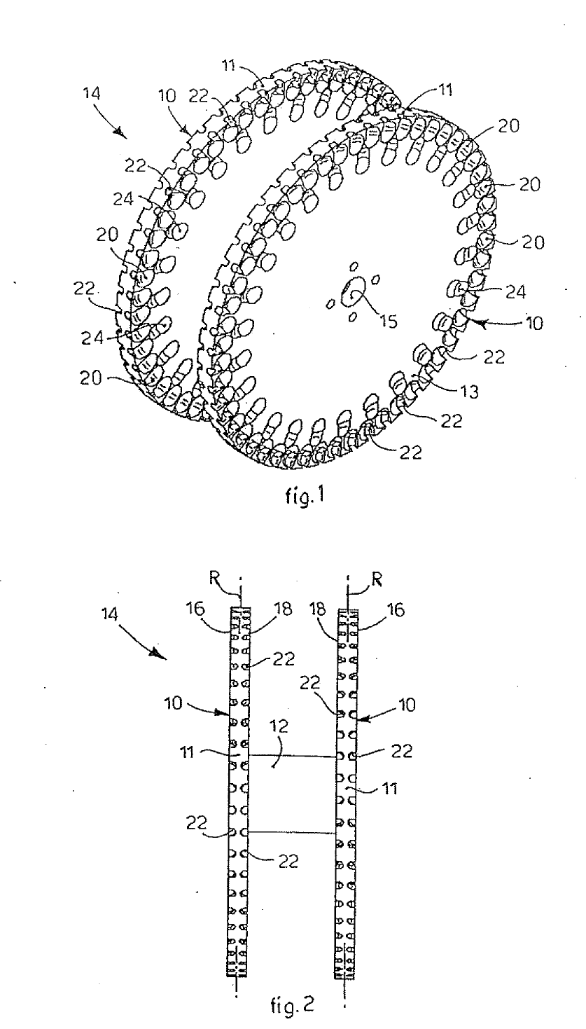

With reference to FIGS. 1 and 2, a disk 10 for the dosage and individual selection of seeds has an axial thickness 11 of determinate dimensions, delimited laterally by two walls 16, 18 facing each other, lying on a plane P, and having a circular peripheral edge 13.

The disk 10 can be used individually or can be assembled, for example in pairs of disks, to define a drum 14 for the dosage and individual selection of seeds.

Assembly occurs by means of a hub 12, coupled with a central hole 15 of each disk 10, with the walls 18 facing toward the inside and the walls 16 facing toward the outside, as can be seen in FIGS. 2 and 4.

Along the circular peripheral edge 13 of each of the two walls 16, 18 housing seatings 20 are made, to define a honeycomb geometry, in each of which a single seed 15 is able to be housed. The seeds 15 are collected by the disk 10 in rotation which takes them from a loading chamber 50, as will be explained in more detail hereafter (FIG. 11).

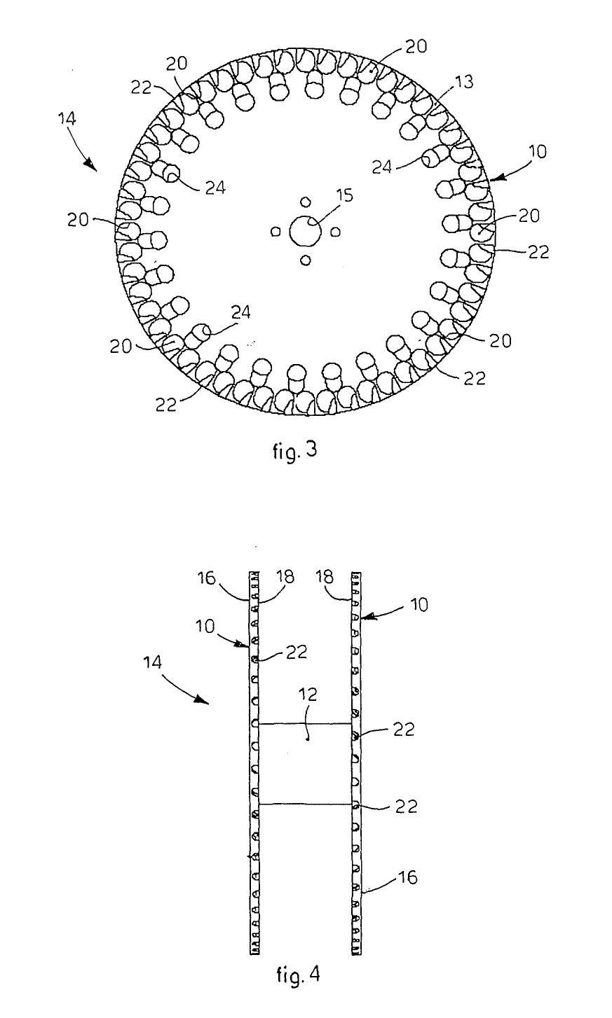

Each of the housing seatings 20 has an aperture 22, made in a radial direction with respect to the centre of the disk 10 (FIGS. 2 and 3). The radial apertures 22 open in the thickness 11 of the disk 10 toward the outside, in substantial correspondence with the circular peripheral edge 13. As is explained in more detail hereafter, the radial apertures 22 act as an outlet for the pressurized air which acts on the disk 10.

Moreover, not on the periphery, but in correspondence with a determinate minor radial distance with respect to the circular peripheral edge 13, cavities or hollows 24 are made, which have the function of mixing the mass of seeds during the loading step. The cavities 24 are made with an angular frequency which can be less than that of the housing seatings 20, as can be seen in the drawings where the cavities 24 are made for every pair of adjacent housing seatings 20.

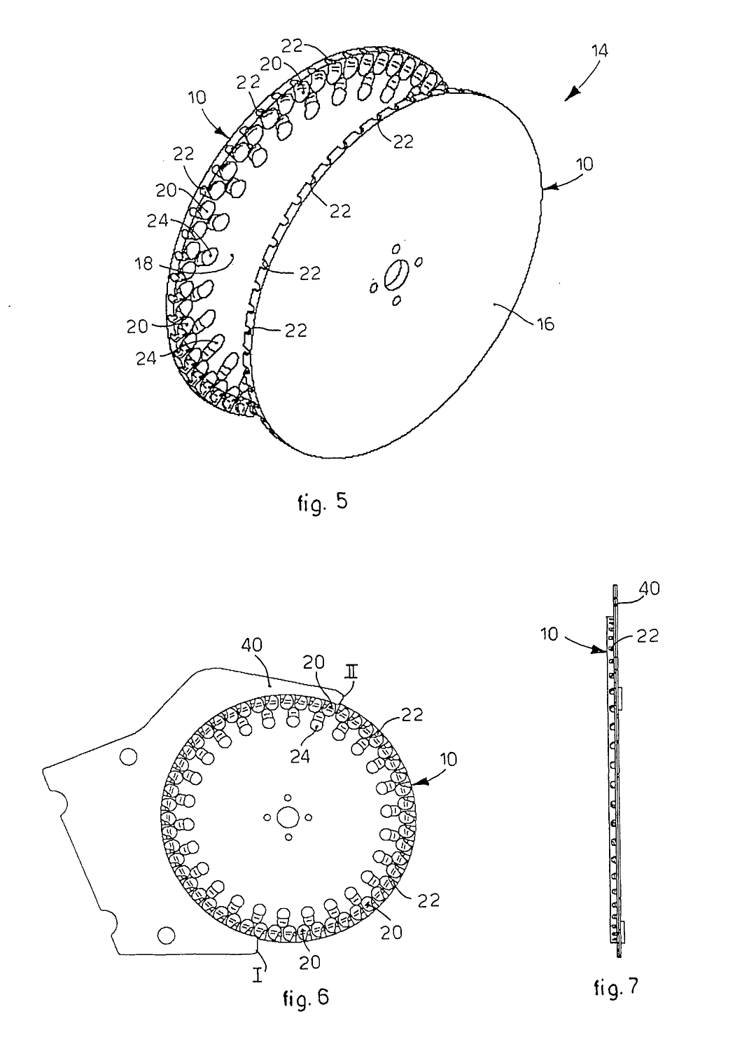

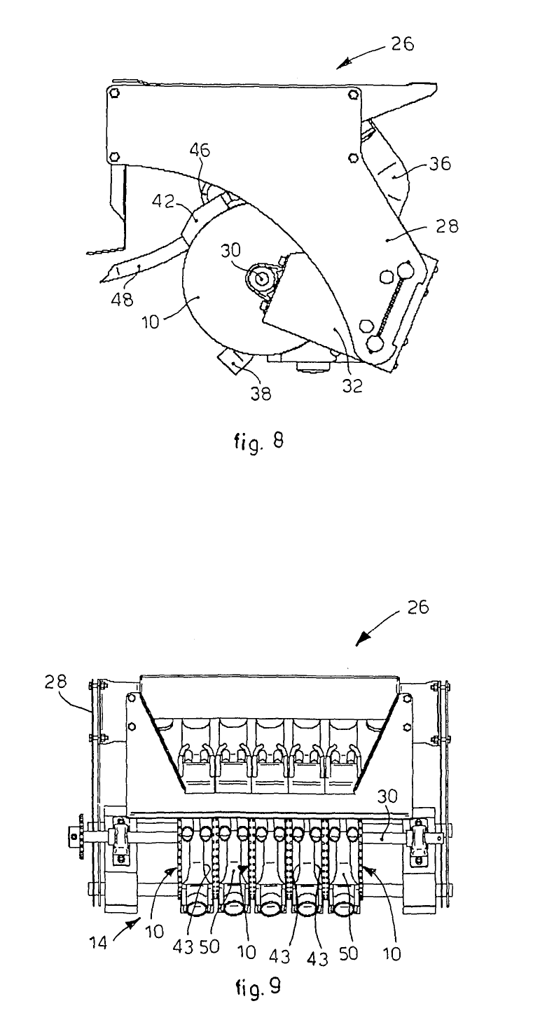

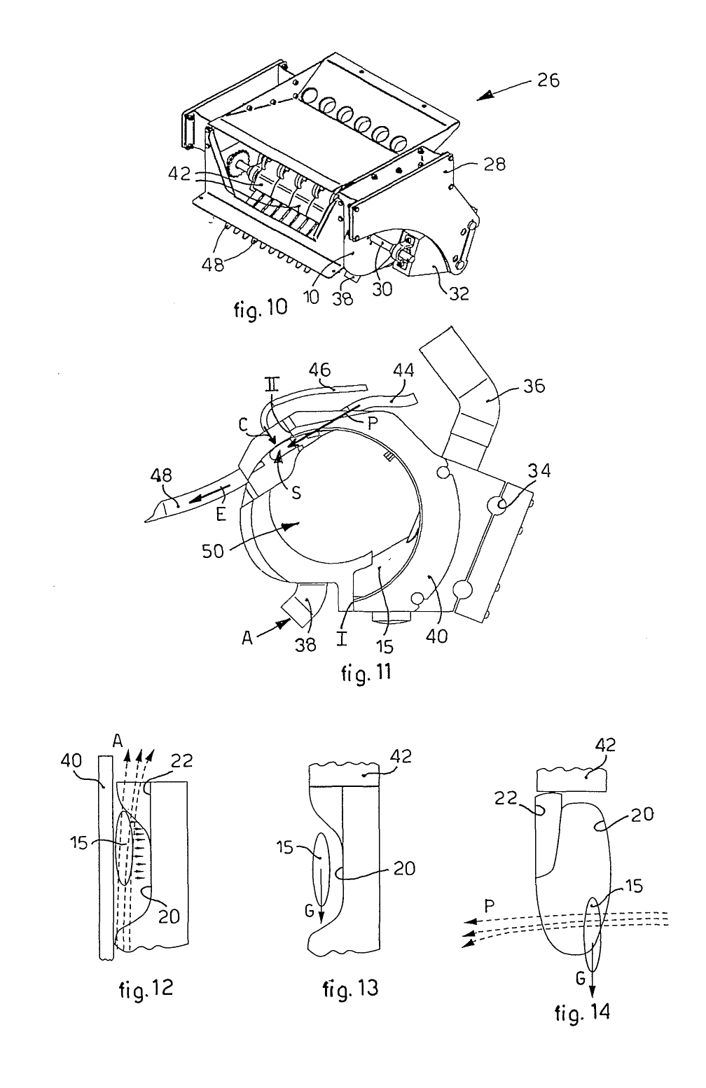

As a variant, the housing seatings 20 for the seeds, and the relative radial apertures 22 through which air is discharged, may be made on only one of the walls 16 and 18, as can be seen in FIGS. 4 and 5.

The drum 14 according to the present invention is assembled in a unit for the dosage and long-distance transport of seeds 26 of an automatic machine for the dosage, the individual selection and the long-distance transport of seeds 15 of the type used in agricultural production, not shown in the drawings.

In this case the drum 14 is formed by six disks 10, of which there are four central double disks, that is, which have their housing seatings 20 on both faces 16 and 18, and two single disks, that is, with the housing seatings 20 only on the internal wall 18, located at the right and left end of the drum 14.

In this way, the unit for the dosage and long-distance transport of seeds 26 in this case is able to distribute ten parallel rows of seeds.

The unit for the dosage and long-distance transport of seeds 26 comprises a frame 28 on which the drum 14 is mounted. The frame 28 in turn is attached to the machine by means of alignment and attachment holes 34.

The drum 14 is made to rotate by means of a transmission shaft 30, supported by support portions 32 of the frame 28.

The disks 10 are mounted, in twos, at the sides of the relative loading chambers 50 for the seeds.

The seeds 15 are fed inside each of the loading chambers 50 by pipes 36, arriving from a loading hopper, not shown in the drawings.

The position of the pipes 36 can be regulated by the operator, so as to be able to vary the discharge height of the seeds 15 into the loading chamber 50. In this way it is possible to regulate the quantity of seeds 15 that are fed into the loading chamber 50.

Furthermore, each of the loading chambers 50 is provided at the lower part with a pressurization pipe 38, able to introduce pressurized air from below.

A retaining edge 40, having an internal profile shaped with a partially circular shape mating with that of the disk 10, is provided coupled laterally with each disk 10. The retaining edge 40 can be made in a piece with the walls of the loading chamber 50, or it can be a separate component, such as a plate, which is suitably mounted.

The retaining edge 40 cooperates with the housing seatings 20 of the disk 10, so as to constitute a barrier to retain the seed and prevent it coming out, for a determinate angular sector of the disk 10.

In particular, the angular sector goes from point I to point II of FIGS. 7 and 11, in correspondence with the two ends of the arc of circumference of the retaining edge 40.

The retaining edge 40, in its circular segment concerned, closes the housing seatings 20 but leaves the radial apertures 22 free.

In this way, air is prevented from coming out in a direction orthogonal to the disk 10, and on the contrary the air is forced to come out through the radial apertures 22.

The air comes out from the disk 10 radially, with a stream substantially co-planar with the plane P on which the disk 10 lies.

In correspondence with point II, a closing element 42 is mounted, also having a circular shaped internal profile, mating with the disk 10.

The closing element 42 is located at the front of a part of the axial thickness 11 of the disk and overlaps a determinate circular sector directly adjacent to the circular sector in which the retaining edge 40 operates. The closing element 42 is able to close the radial apertures 22, leaving the housing seatings 20 for the seeds free.

The loading chamber 50 is provided at the upper part with an acceleration pipe 44, able to introduce a stream of accelerating air, indicated by the arrow P, toward the peripheral portion of the disk 10 that is closed by the closing element 42, so as to hit with a stream of accelerating air the seeds 15 that are passing in this zone. The direction of the stream of air arriving from the acceleration pipe 44 is substantially tangential to the disk 10 and allows to accelerate the seed 15 toward the exit and take it to its destination.

This happens because there is a need to transport the individual seed 15 a long distance.

To this end, in a direction aligned with the stream of air P, an expulsion pipe 48 is provided, through which the seeds 15 accelerated by the pressurized air of the acceleration pipe 44 can be transported outside, as indicated by the arrow E FIG. 11).

A third upper stream of air may be provided, indicated by the arrow C, which is supplied by a pipe 46, through the closing element 42, so as to be substantially radial to the disk 10, that is, aligned with the radial apertures 22 that transit here on each occasion (FIG. 11).

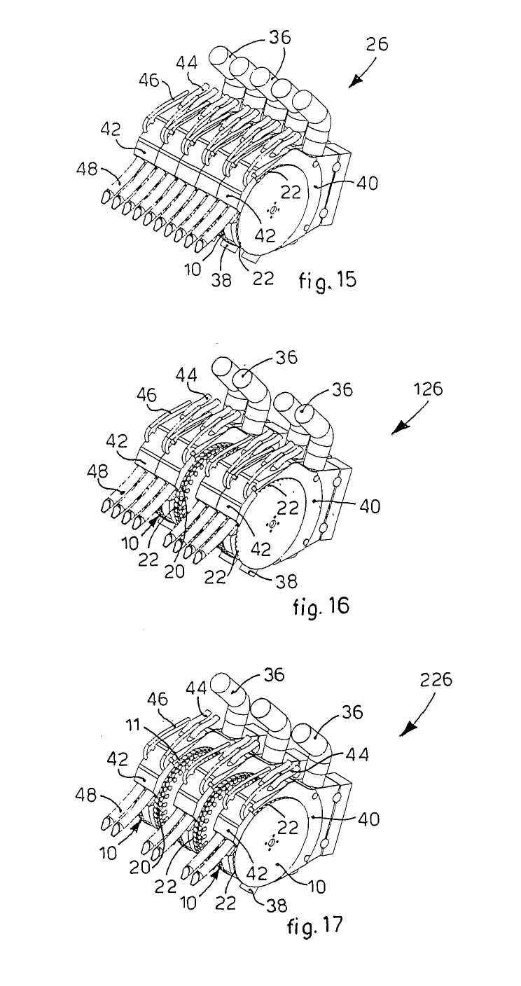

FIGS. 15, 16 and 17 show variants of the dispositions of the disks 10 in a unit for the dosage and long-distance transport of seeds 26 according to the present invention.

There may be a single drum 14, with six disks 10, of which four double disks and two single disks (FIG. 15).

Or, in the variant indicated by the reference number 126, two different drums 14 can be mounted, each of which formed by three disks 10, as in FIG. 16.

Finally, in the variant indicated by the reference number 226, there can be three drums 14, each one consisting of two disks 10 (FIG. 17).

It is also clear that the geometric and positioning conformations of the disks 10 and the drum 14 as described above can be repeated in a modular manner, so as to be able to operate on working fronts of varying length, even very long, from a few meters to as much as 20 meters.

The unit for the dosage and long-distance transport of seeds 26 functions as follows.

The pressurization of the loading chamber 50 is activated by means of the pressurization pipe 38 and the seeds 15 are fed by means of the feed pipe 36 and accumulate on the bottom of the loading chamber 50.

The disposition of the pressurization pipe 38 on the bottom of the loading chamber 50 is advantageous in that it prevents the formation of vortexes and phenomena of cavitation in the loading chamber 50 and allows to make the pressure uniform, obtaining a constant pressure equally distributed on both walls 18 of the disks 10 that delimit the loading chamber 50.

The drum 14 is made to rotate, in this case and with reference to the attached drawings, in an anti-clockwise direction, so that the disks 10, with their honeycomb part, collect the seeds 15 present in the loading chamber 50, which are loaded one by one into the respective housing seatings 20.

Advantageously, the cavities 24 mix the mass of seeds 15 in the loading chamber 50, promoting the mixing and positioning of the seeds in the housing seatings 20.

In the segment of circumference that goes from point I to point II, the housing seatings 20 are laterally covered by the retaining edge 40.

In this segment, each seed 15 is held in the seating by the presence of the retaining edge 40 and by a special combination of forces that leads to a balance between radial centrifugal force due to the rotation of the disk 10, suction force that makes the seed 15 adhere to the housing seating 20 and the force of the weight of the seed 15 itself (as shown schematically in FIG. 12).

In particular, the pressurized air of the loading chamber 50 can pass freely through the radial apertures 22, which are open in the segment that goes from point I to point II.

The stream of air, indicated by the arrows A in FIG. 12, passes close to the housing seating 20 and at considerable speed, causing a depression due to the Venturi effect, which acts on the seed 15.

The more the seed 15 is kept toward the radial aperture 22, the narrower the section of the passing air through the radial aperture 22 will be, and consequently the greater will be the outlet speed of the air, the adhesion effect of the seed 15 due to depression and the stability of the seed 15.

As can be seen in FIG. 12, the seed tends to remain in the housing seating 20, against the radial aperture 22, slightly displaced toward the outside in a radial direction.

It is clear that the outlet of the air through the radial apertures 22 can be choked, so as to modify the suction force that holds the seed 15, by providing profiles, thicknesses or adjustable mobile units that partly occlude the radial apertures 22, calibrating the section of the outlet holes, this according to the mass and shape of the seed and the speed of rotation of the disk 10.

For example, in particular in the loading zone a little after the bottom of the loading chamber 50, a profile or additional edge may be provided, located at the front of the disk 10, in cooperation with an angular segment of the axial thickness 11 of the disk 10.

In particular, the calibration of the outlet section of the radial apertures 22 is made according to the specific weight of the seeds 15, so that, when the type of seed changes (for example from soya to maize) it is not necessary to change the whole disk 10, it is sufficient to vary the outlet section of the radial apertures 22, to set the desired retaining force that acts on the seeds 15.

Another possibility for choking can be to vary the thickness of the retaining edge 40, so that it partly overlaps the disk 10, partly occluding the radial apertures 22.

At the end of the segment that goes from point I to point II, the radial apertures 22 are stopped by the closing element 42. In this way, the pressurized air no longer exits at high speed and the Venturi effect and the suction acting on the seed 15 come to an end (FIG. 13).

In this case the seed 15, no longer adhering to the housing seating 20, would tend to fall downward due to gravity because of its weight, as indicated by the arrow G, and moves slightly toward the center of the housing seating 20, as can be seen in FIG. 13. This is the so-called point of detachment of the seed 15, indicated by the arrow S in FIG. 11.

However, the stream of air P arriving from the pipe 14 is directed precisely into the zone of the point of detachment S where the depression force is no longer active, and it hits the seed 15, while the latter has moved slightly downward due to gravity, as can be seen in FIG. 14.

The stream of air P, at a much higher speed than the air arriving from the pressurization pipe 38 located at the lower part, accelerates the seed 15, in a substantially tangential direction, directing it to the expulsion pipe 48, so as to obtain the desired dosage and individual selection of the seeds 15.

Once the seed 15 has been discharged, the disk 10 continues in its rotation course until it again reaches the zone on the bottom of the loading chamber 50 where a new seed 15 is loaded, to then continue in the rotation.

In this last segment of rotation, there are windows 43 made on the walls of the loading chamber 50, which leave free the honeycomb parts of the disk 10 where the housing seatings 20 are made, so as to discharge any possible impurities or foreign bodies.

In substance, once the seed 15 has been loaded into its housing seating 20, it is subjected to three conditions, of different time duration:

a first condition, which goes from point I to point II, is a retaining condition in which the seed 15 is retained in the housing seating 20, thanks to the Venturi effect of the pressurized air that is freed through the radial apertures 22 and thanks to the lateral cooperation with the retaining edge 40;

a second condition, in correspondence with the point of detachment and with a practically instantaneous duration, in which there is no longer any discharge of pressurized air, so that the seed 15 tends to fall due to gravity inasmuch as it is no longer subjected to a depression force attracting it against the bottom of the housing seating 20;

a third condition in which the seed 15, in substantial correspondence with the point of detachment, is subjected to the force of acceleration of the stream of air P, which transports it toward the expulsion pipe 48, from where it is transported long-distance; since there is no lateral retaining edge 40, the seed can pass over the housing seating 20 and be discharged from the disk 10.

The location of the pressurization pipe 38 on the bottom of the loading chamber 50 gives another advantage, that the circulation of the air produced by it is such that the zone of the point of detachment S, due to its upper position opposite the inlet of the pressurization pipe 38, is in a condition of falling air pressure, which is added to the effect of the closing element 42 on the radial apertures 22.

The radial disposition of the apertures 22 is advantageous inasmuch as it allows to couple the disk 10 or construct it specularly, so that the air of contiguous disks can have a radial escape route that does not compromise functioning.

As a variant, instead of using the acceleration stream of air P, it is possible to cause the seed 15 to fall simply due to the force of gravity and rotation inertia, once there is no longer, in the point of detachment where the radial apertures 22 are closed, the lateral retaining edge 40 and the effect of holding the seed in the housing seating due to depression. In this case, the seed 15 is discharged due to the simple free fall due to gravity, not through the expulsion pipe 48 or other obligatory exit routes.

It is also possible to provide that the expulsion occurs pneumatically, only by means of, or with the aid of, the stream of air arriving from the pipe 46. The pipe 46 is able to direct the desired stream of air near to and in a position opposite the point of detachment, that is, in a radial direction common to the exit direction through the radial apertures 22, in order to guarantee a uniform detachment of the seed 15, and also to clean the radial apertures 22 of the disk 10 of any possible residual impurities and foreign bodies.

It is clear that modifications and/or additions of parts and/or steps may be made to the disk for the dosage and individual selection of seeds, the unit for the dosage and long-distance transport of seeds comprising said disk, and the method for the dosage, individual selection and long-distance transport of seeds as described heretofore, without departing from the field and scope of the present invention.

It is also clear that, although the present invention has been described with reference to specific examples, a person of skill in the art shall certainly be able to achieve many other equivalent forms of disk for the dosage and individual selection of seeds, unit for the dosage and long-distance transport of seeds comprising said disk, and method for the dosage, individual selection and long-distance transport of seeds, having the characteristics as set forth in the claims and hence all coming within the field of protection defined thereby.

1. A disk for the dosage and individual selection of seeds, having a determinate axial thickness delimited by two facing circular walls or surfaces, and comprising housing seatings made along the peripheral edge of one or both circular walls or surfaces and passage ways that open from the housing seatings toward the outside of the disk, for the passage of a stream of air, wherein the passage ways are made on the axial thickness, in a radial direction with respect to the center of the disk, wherein the disk further comprises, along an angular sector of its circumference, a retaining edge that closes the housing seatings retaining the seeds inside them but leaving the passage ways free, and, at the end of the retaining edge, a closing element, that closes the passage ways and leaves the housing seatings for the seeds free.

2. The disk as in claim 1, wherein the housing seatings are made on both the circular walls or surfaces.

3. The disk as in claim 1, wherein the housing seatings are made at a radial distance substantially coincident with the radius of the disk.

4. The disk as in claim 1, wherein cavities are provided on the disk to function as elements to mix the seeds, which are made on at least one of the two circular walls or surfaces, at a smaller radial distance than the radial distance of the housing seatings.

5. A unit for the dosage and long-distance transport of seeds comprising at least a disk for the dosage and individual selection of seeds as in claim 1.

6. The unit for the dosage and long-distance transport of seeds as in claim 5, comprising a plurality of disks mounted on a rotary shaft, so as to achieve one or more drums for dosing and individual selection.

7. The unit for the dosage and long-distance transport of seeds as in claim 5, comprising at least a loading chamber into which the seeds are fed and into which a first stream of pressurized air is fed, at least a relative disk being mounted in cooperation with said loading chamber, so that the loading chamber is closed to the passage from outside of the first stream of pressurized air, except for at least the passage ways of each disk.

8. The unit for the dosage and long-distance transport of seeds as in claim 7, comprising at least a retaining edge made laterally to the loading chamber in cooperation with the peripheral edge of the disk, for a determinate first angular sector of the disk, in order to retain the seeds in the housing seatings.

9. The unit for the dosage and long-distance transport of seeds as in claim 8, comprising a first pressurization pipe located on the bottom of the loading chamber and able to introduce inside the loading chamber the first stream of pressurized air, which first stream is able to pass outside the loading chamber only through the passage ways of each disk, creating depression conditions able to keep the seeds in the respective housing seatings.

10. The unit for the dosage and long-distance transport of seeds as in claim 9, comprising a closing element located upstream of the retaining edge with respect to the direction of rotation of the disk, which closing element is located in cooperation with the axial thickness of the disk for a determinate second angular sector of the disk, said closing element closing the passage ways only in said second angular sector, preventing the exit of the first stream of air.

11. The unit for the dosage and long-distance transport of seeds as in claim 10, comprising a second acceleration pipe, which is located substantially on the top of the loading chamber and is able to introduce a second stream of accelerating air toward the seeds passing along the second angular sector in which the passage ways are closed by the closing element, so as to act on the seed, accelerating the seed toward an expulsion pipe.

12. The unit for the dosage and long-distance transport of seeds as in claim 10, comprising a third pipe to introduce into the loading chamber a third stream of air directed toward the disk substantially aligned with a relative passage way of the disk.

13. A machine for the dosage, individual selection and long-distance transport of seeds comprising a unit for the dosage and long-distance transport of seeds as in claim 5.

14. A method for the dosage, individual selection and long-distance transport of seeds comprising a first step of loading a single seed into housing seatings made along the peripheral edge of one or both the circular walls or surfaces of a disk made to rotate around its axis, the method also comprising:
a second step in which, for a first determinate angular sector of rotation of the disk, a first stream of pressurized air is achieved exiting radially, with respect to the disk, from each of the housing seatings, so as to cause the seed to be retained in the relative housing seating, by means of a suction effect generated by the stream of air and by means of a retaining edge that closes the housing seatings; and
a third step in which, for a second determinate angular sector of rotation of the disk, in correspondence with a determinate point of detachment, the exit of the first pressurized stream of air is prevented, so as to eliminate said suction effect acting on the seed, so as to allow the seed to exit from the housing seating.

15. The method as in claim 14, wherein the seed is discharged from the disk due to free fall, thanks to the action of the force of gravity.

16. The method as in claim 14, also comprising a fourth step in which the seed, in substantial correspondence with the point of detachment, is subjected to the force of acceleration of a second stream of accelerating air, which transports the seed toward the outside of the disk.

17. The method as in claim 14, wherein the seed, in substantial correspondence with the point of detachment, is subjected to a third stream of pressurized air, directed substantially radial, which transports the seed toward the outside of the disk.
